(19) United States
(12) Patent Application Publication
(10) Pub. No.: US 2005/0172002 A1
(43) Pub. Date: Aug. 4, 2005

(54) System and method for remote configuration

(76) Inventor: Denis Maurin, Milford, CT (US)

Correspondence Address: PERMAN & GREEN, 425 POST ROAD, FAIRFIELD, CT, 06824, US

(21) Appl. No.: 10/768,814

(22) Filed: Jan. 30, 2004

(51) Int. Cl. G06F 15/16; G06F 15/177

(52) U.S. Cl. 709/206; 709/222

(57) ABSTRACT

A method of remotely configuring a mailing system includes initiating communication between the mailing system and a service provider infrastructure, conveying mailing system identification to the service provider infrastructure, creating a procedures list including programs and revisions required for additional functions and options to be installed on the mailing system, further including the order of performing the revisions and installing the programs, and executing the procedures list.

### BACKGROUND OF THE INVENTION

1. Field of the Invention

The present invention relates to remote configuration, and, more particularly, to techniques for remotely configuring a mailing system.

2. Brief Description of Related Developments

A postal customer may use a mailing system which incorporates a Postal Security Device (PSD) to secure the proof of payment of postal indicia. The indicia is generally applied to mailing items and identifies the value of the postage applied and other information. The customer may purchase postage and the purchased value may be stored in the PSD. As the postage indicia is applied to items, the value applied may be deducted from the stored value. Once postage indicia is applied, the item may then be dropped into the collection stream of the particular postal system and subsequently processed for delivery.

The mailing system may communicate with a service provider infrastructure to have postage funds replenished. Communication may occur over a network, for example, a telephone line with a modem, or the Internet, where the added postage is deducted from an account usually maintained with the service provider or a trusted third party administrator, for example, a financial institution. Machines with this type of communication capability may initiate communication with the service provider either automatically or by receiving input from a user.

Occasionally, additional functions or options may become available for a mailing system. Generally, the additional functions or options are provided on media, for example, an integrated circuit, compact disk, floppy disk, etc. However, physically delivering a program or data on media requires ordering the function or option, shipping the media, and installation by a user or technician.

It would be advantageous to supply additional functions or options automatically using remote configuration techniques.

### SUMMARY OF THE INVENTION

The present invention is directed to a method of remotely configuring a mailing system that includes initiating communication between the mailing system and a service provider infrastructure, conveying mailing system identification to the service provider infrastructure, creating a procedures list including programs and revisions required for additional functions and options to be installed on the mailing system, further including the order of performing the revisions and installing the programs, and executing the procedures list.

### BRIEF DESCRIPTION OF THE DRAWINGS

The foregoing aspects and other features of the present invention are explained in the following description, taken in connection with the accompanying drawings, wherein:

FIG. 1 shows a block diagram of a system suitable for practicing the invention;

FIG. 2 shows a general block diagram of a mailing system according to the disclosed embodiments; and

FIG. 3 shows a flow diagram of operations associated with the present invention.

### DETAILED DESCRIPTION OF THE PREFERRED EMBODIMENTS

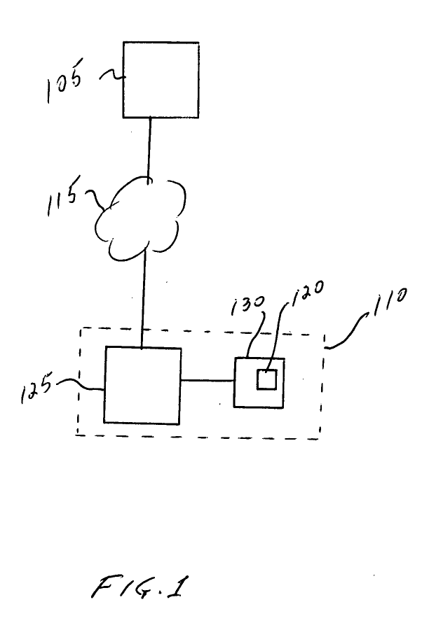

FIG. 1 shows a block diagram of a system 100 suitable for practicing the invention disclosed herein. Although the present invention will be described with reference to the embodiment shown in the drawings, it should be understood that the present invention can be embodied in many alternate forms of embodiments. In addition, any suitable size, shape or type of elements or materials could be used.

System 100 includes a mailing system 105, connected to a service provider infrastructure 110 through a network 115. The mailing system 105 generally provides indicia that has value, for example, postage, tickets allowing admission to an event or allowing the use of a service, and the like. The service provider infrastructure 110 provides updates, additional functions, replacement programs, data tables and other data and information to the mailing system.

It is a feature of the present invention that communication is initiated between the mailing system 105 and the service provider infrastructure 110 and information identifying the mailing system 105 is sent to the service provider infrastructure 110. The service provider infrastructure 110 determines which additional functions and options are to be installed on the mailing system 105 and creates a list of procedures 120 to be accomplished in order to install those additional functions and options. When the list 120 is complete, the service infrastructure then performs the procedures on the list 120, installing the new functions and options.

The service provider infrastructure 110 include a server 125 and a database 130 for storing programs and information required to install the additional functions and options. The list of procedures 120 may also be stored in the database 130. System 100 may include other suitable components or functions for implementing the present invention.

Referring to FIG. 1 in greater detail, server 125 is coupled to the network 115. One or more marking devices, in this example mailing system 105, are also coupled to the network 115, and may communicate bi-directionally through the network 115 with server 125. While a single server 125 is shown, server 125 may represent a plurality of servers, and these servers may be situated at a single location, or they may be widely distributed and remotely sited. For example, a plurality of distributed servers 125 may be used for servicing mailing systems 105 in different geographic locations, according to particular postal regulations, such as North America, South America, Europe, Africa, Japan and Southeast Asia. Alternately, a single server 125 can be used for servicing all mailing systems 105.

Server 125 may also include or be connected to one or more databases 130 that may store, in addition to downloads, data related to the status, capabilities, characteristics or other information about the one or more mailing systems 105. The one or more databases 130 may be centralized at a specific location or may be distributed among a number of distributed computers.

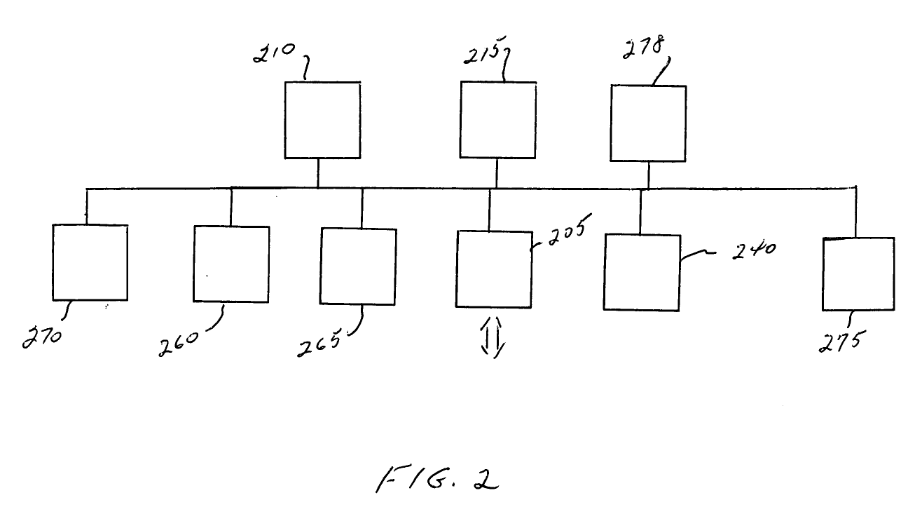

FIG. 2 shows a general block diagram of mailing system 105. Mailing system 105 may include a communications port 205 and a microprocessor 210 for performing electronic accounting and control functions, franking functions, and handling functions according to programs stored in a storage device 215. Some of these functions or subsets of these functions may be grouped within a secure perimeter as what is commonly referred to as a Postal Security Device (PSD).

Microprocessor 210 typically performs electronic accounting functions in relation to franking items with indicia showing a value. Data associated with the accounting functions may include an accumulated total value of credit entered into the PSD, an accumulated total value of charges dispensed by the PSD by franking items, a count of the number of items franked, and a count of the number of items franked with a charge in excess of a predetermined value. The accumulated total value of credit may be stored in an ascending credit register 260, and the accumulated total value of postage charges dispensed may be stored in a descending register 265. The various registers may be located in storage device 215.

The franking functions typically include marking items with indicia and reporting the number of items, value marked and other parameters to the accounting functions.

The control functions may include exchanging information with a user through a user interface 278, uploading postage funds, downloading accounting data, and secure communications with server 125 through network 115, including implementing new public key, private key combinations. According to the present invention, the control functions may also include participating in communications with the service provider infrastructure 110 and sending identifying information to server 125 so that the server may determine which additional functions and options are to be installed on the mailing system 105, create a list of procedures 120 to be accomplished in order to install those additional functions and options, and perform the procedures.

To support the control functions, storage device 215 may also include a PSD Public Key, Private Key combination specific to the PSD, a Vendor Public Key specific to the vendor of mailing system 105, a mailing system identification number, a mailing system serial number, configuration identification, information regarding software installed on mailing system 105, including version numbers, the size of storage 215 and date, and other parameters.

The mailing system 105 may also have or be integral to a device for marking objects with indicia, shown in this embodiment as a printer 240. The mailing system may also include other devices that support mailing acticites, for example, an inserter 270, a scale or weighing device 275, and any other devices or equipment as required.

Network 115 may include any suitable communications network, for example, the Public Switched Telephone Network (PSTN), a wireless network, a wired network, a Local Area Network (LAN), a Wide Area Network (WAN), virtual private network (VPN) etc. Mailing system 105 may communicate with service provider infrastructure 110 using any suitable protocol, or modulation standard, for example, X.25, ATM, TCP/IP, V.34, V.90, etc.

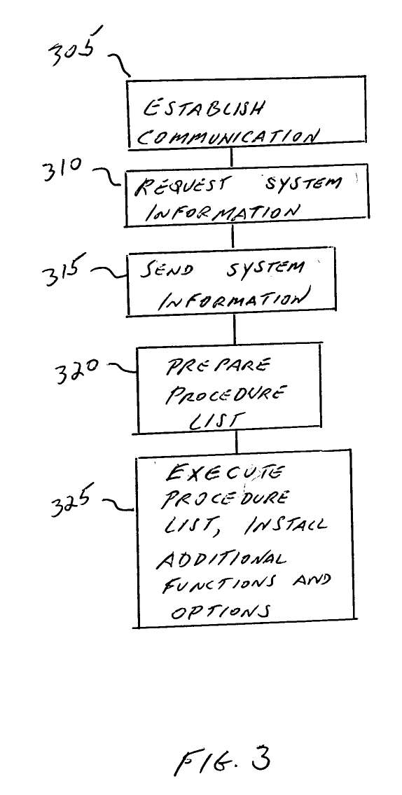

The operation of an embodiment of the present invention will now be described with reference to FIG. 3. A user may request additional functions as they become available, or may have an account set up with the service provider that provides additional functions and options as they become available. The user request may be made directly to the service provider, for example through a telephone call, by written request, through an Internet web page, etc., or may be made through user interface 278 of mailing system 105. Mailing system 105 then communicates with server 125 through network 115 as part of an automatic or user initiated communication as shown in block 305. Server 125 responds by requesting identification information from mailing system 105 as shown in block 310. The mailing system 105 then sends identifying information as shown in block 315. The information may include a PSD Public Key, a Vendor Public Key, the mailing system identification number, serial number, mailing system configuration identification, information regarding software installed on mailing system 105, including version numbers, and the size of storage 215.

In block 320, the server 125 determines which additional functions and options are to be installed on the mailing system 105 and the order in which they must be installed, and creates the list of procedures to be accomplished in order to install those additional functions and options. For example, a new type of marking function becomes available, and the user has a subscription that allows installation when the new marking function is available. The server 125 analyzes the identifying information from the mailing system 105 and in conjunction with information in database 130, determines that an operating system revision, several application program revisions, and a new program are required in order for the mailing system 105 to operate the new marking function. The server 125 further determines that one of the application revisions must be performed first, then the operating system revision, then the new program installation, and then the remaining application revisions. The server 125 then creates the procedures list 120, including the revisions to be made, the new program to be installed and the order in which the revisions and installation must take place.

Note that the term options may include toggling on or off or modifying particular parameters of the mailing system. For example, it may be desirable to enable or disable an ink management system within mailing system 105, expand department numbers, implement a different weighing mechanism etc. These changes may also be implemented using the techniques described herein.

In block 325. the server executes the procedures list 120, retrieving programs and information as required from database 130, and installing revisions and new programs in the mailing system 105 in the order required.

Thus, the service provider infrastructure 110, through the server 125 makes decisions about which additional functions and options are available for the mailing system, and which revisions and additional programs may be required to provide the additional functions and options. The service provider infrastructure 110 then makes further decisions regarding the order that the revisions and programs are to be performed in order to install the new functions and options.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A method of remotely configuring a mailing system comprising:
initiating communication between the mailing system and a service provider infrastructure;
conveying mailing system identification to the service provider infrastructure;
creating a list procedures for installing one or more functions on the mailing system; and
executing the list of procedures.

2. The method of claim 1, wherein communication is initiated at the request of a user of the mailing system.

3. The method of claim 1, wherein communication is initiated automatically upon availability of the one or more functions.

4. The method of claim 1, wherein the mailing system identification includes a mailing system configuration identification and a size of a storage of the mailing system.

5. The method of claim 4, further comprising analyzing the mailing system configuration identification to determine the list of procedures.

6. The method of claim 1, wherein the list of procedures includes an order of performing the procedures.

7. The method of claim 1 wherein the list of procedures includes operating system and application program revisions required for installing the one or more functions.

8. A system for remotely configuring a mailing system comprising:
a service provider infrastructure that communicates with the mailing system; and
a server in the service provider infrastructure for receiving mailing system identification from the mailing system, for creating a list of procedures for installing one or more functions on the mailing system, and for executing the list of procedures.

9. The system of claim 8, wherein the service provider infrastructure communicates with the mailing system communication at the request of a user of the mailing system.

10. The system of claim 8, wherein the service provider infrastructure communicates with the mailing system communication automatically upon availability of the one or more functions.

11. The system of claim 8, wherein the mailing system identification includes a mailing system configuration identification and a size of a storage of the mailing system.

12. The system of claim 11, wherein the server operates to analyze the mailing system configuration identification to determine the list of procedures.

13. The system of claim 8, wherein the list of procedures includes an order of performing the procedures.

14. The system of claim 8, wherein the list of procedures includes operating system and application program revisions required for installing the one or more functions.
